(19) United States
(12) Patent Application Publication
(10) Pub. No.: US 2024/0242040 A1
(43) Pub. Date: Jul. 18, 2024

(54) METHOD AND SYSTEM FOR DETERMINING A MEASURE OF CONCEPTUAL CONSISTENCY IN LARGE LANGUAGE MODELS

(71) Applicant: SRI International, Menlo Park, CA (US)

(72) Inventors: Michael COGSWELL, Yardley, PA (US); Ajay DIVAKARAN, Monmouth Junction, NJ (US); Yunye GONG, West Windsor, NJ (US); Pritish SAHU, Piscataway, NJ (US)

(21) Appl. No.: 18/541,035

(22) Filed: Dec. 15, 2023

Related U.S. Application Data
(60) Provisional application No. 63/439,813, filed on Jan. 18, 2023.

(51) Int. Cl. G06F 40/40

(52) U.S. Cl. CPC G06F 40/40

(57) ABSTRACT

Embodiments of the present principles generally relate to methods, apparatuses and systems for determining a measure of conceptual consistency in large language models for understanding of relevant concepts. In some embodiments, a method for measuring conceptual consistency may include prompting an LLM in order to extract answers to background queries and anchor tasks. The method also includes comparing background knowledge facts for a given anchor task associated with known answers with facts extracted from the LLM to determine an LLM performance. The method also includes determining a background knowledge score and an anchor task score based on the LLM's performance. The method also includes determining a conceptual may include score for the LLM by predicting the anchor task score from the background knowledge score. The method also includes outputting an indication of the conceptual may include score.

### RELATED APPLICATION

This application claims benefit to U.S. Provisional Patent Application Ser. No. 63/439,813, filed 18 Jan. 2023 and entitled “Conceptual Consistency Based Technique For Understanding Large (Foundation) Models,” which is hereby incorporated herein in its entirety by reference.

### FIELD

Embodiments of the present principles generally relate to Large Language Models (LLMs) and, more particularly, to methods and systems for determining a measure of conceptual consistency in LLMs for understanding of relevant concepts.

### BACKGROUND

Large Language Models (LLMs) are a type of artificial intelligence (AI) algorithm that uses deep learning techniques and massively large data sets to understand, summarize, generate and predict new content. LLMs have had many exciting recent successes. These include high performance and even emergent capabilities using just zero or few-shot prompting, but overall performance is still low compared to humans on a wide range of tasks for even the largest models. A popular explanation of low performance and inconsistencies is that LLMs are simply learning to mimic the data used to train them, and this basic pattern recognition limits generalizability, in the case of LLMs exposing the limits of any understanding. For example, if a LLM answers “yes” to the question “Are mountains tall?”, then does it know what a mountain is? Can one rely on it responding correctly or incorrectly to other questions about mountains? The success of LLMs indicates they are increasingly able to answer queries like these accurately, but that ability does not necessarily imply a general understanding of concepts relevant to the anchor query.

Traditionally the literature on interpretability and explainability attempts to address the low performance and inconsistency problems. However, these approaches tend to be focused on linguistic features and simple invariances, of which there are many, but the resulting analysis cannot capture a model's understanding of underlying concepts.

Thus, there is a need for improved techniques and metrics to better measure a LLM's understanding of relevant concepts.

### SUMMARY

Embodiments of the present invention generally relate to conceptual consistency based methods and systems for understanding LLMs, as shown in and/or described in connection with at least one of the figures. More specifically, embodiments of the invention include a method, apparatus and computer readable media for determining a measure of conceptual consistency in large language models for understanding of relevant concepts. In some embodiments, a method for measuring conceptual consistency may include prompting an LLM in order to extract answers to background queries and anchor tasks. The method also includes comparing background knowledge facts for a given anchor task associated with known answers with facts extracted from the LLM to determine an LLM performance. The method also includes determining a background knowledge score and an anchor task score based on the LLM's performance. The method also includes determining a conceptual may include score for the LLM by predicting the anchor task score from the background knowledge score. The method also includes outputting an indication of the conceptual may include score.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present principles can be understood in detail, a more particular description of the principles, briefly summarized above, may be had by reference to embodiments, some of which are illustrated in the appended drawings. It is to be noted, however, that the appended drawings illustrate only typical embodiments in accordance with the present principles and are therefore not to be considered limiting of its scope, for the principles may admit to other equally effective embodiments.

FIG. 1 depicts a block diagram of an exemplary computing system including components for conceptual consistency determination system in accordance with some embodiments of the present disclosure;

FIG. 2 depicts a flow diagram depicting a method for measuring conceptual consistency of a large language model (LLM), in accordance with at least one embodiment of the invention.

FIG. 3 depicts positive and negative concepts used for extracting background knowledge of an LLM), in accordance with at least one embodiment of the invention.

FIG. 4 is a graph of conceptual consistency scores for existing LLMs determined according to one or more embodiments described herein.

FIGS. 5A and 5B is a graph of background knowledge scores and anchor task scores for existing LLMs determined according to one or more embodiments described herein.

FIG. 6 is a scatter plot of background knowledge score vs conceptual consistency score for existing LLMs, according to one or more embodiments described herein.

FIGS. 7A and 7B depict conceptual consistency computed for different subsets of relations and concepts for existing LLMs, according to one or more embodiments described herein.

FIG. 8 is a simplified block diagram of a computer system, according to one or more embodiments.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present principles generally relate to methods, apparatuses and systems for determining a measure of conceptual consistency in large language models for understanding of relevant concepts. This disclosure describes inventive concepts with reference to specific examples. However, the intent is to cover all modifications, equivalents, and alternatives of the inventive concepts that are consistent with this disclosure. It will be apparent, however, to one of ordinary skill in the art that the present approach can be practiced without these specific details. Thus, the specific details set forth are merely exemplary and are not intended to limit what is presently disclosed. The features implemented in one embodiment may be implemented in another embodiment where logically possible. The specific details can be varied from and still be contemplated to be within the spirit and scope of what is being disclosed.

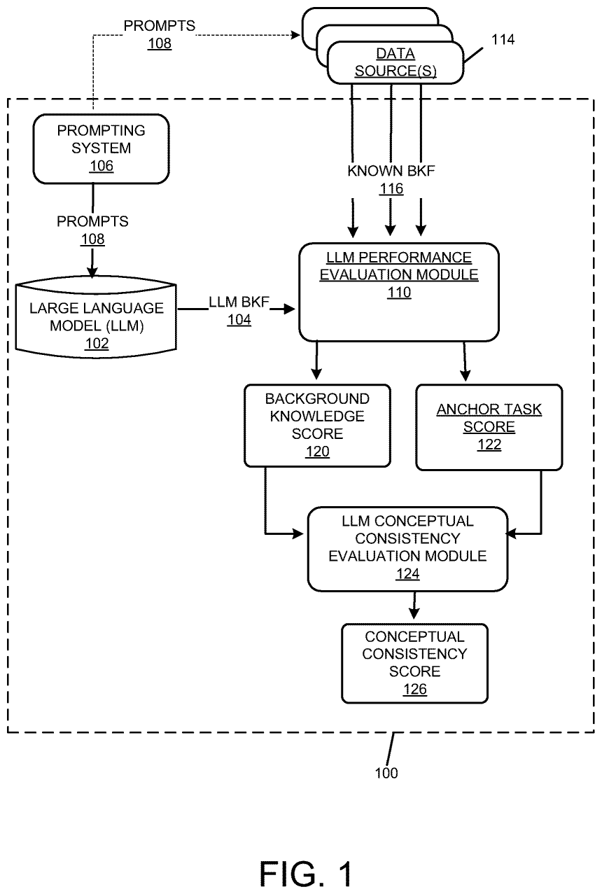

Embodiments of the present disclosure describe techniques to determine a conceptual consistency metric for LLMs to measure the LLMs' understanding of relevant concepts. This novel metric measures how well a model can be characterized by finding out how consistent its responses to queries about conceptually relevant background knowledge are. To compute this conceptual consistency metric, background knowledge is extracted by traversing paths between concepts in a knowledge base and then try to predict the model's response to the anchor query from the background knowledge. The performance of current LLMs is investigated in a commonsense reasoning setting using the CSQA (Complex Sequential Question Answering) dataset and the ConceptNet knowledge base (data sources 114 in FIG. 1). While conceptual consistency, like other metrics, does increase with the scale of the LLM used, it was found that many existing popular models do not necessarily have high conceptual consistency. The analysis of these existing popular models also shows significant variation in conceptual consistency across different kinds of relations, concepts, and prompts. This serves as a step toward building models that humans can apply a theory of mind to, and thus interact with intuitively.

Humans use a Theory of Mind which allows us to understand other agents (i.e., people) by attributing beliefs, intentions, and desires to them in a way that allows us to usefully predict their behavior. Beliefs are most relevant here, and should be conceptual in order to best support human understanding. If this kind of understanding is applied to LLMs, it could be better predicted that the model is more likely correct about a particular aspect of a topic/subject if it knows about the topic/subject generally than if it does not. For example, a person might use a similar line of reasoning to guess how a LLM would answer the following question: “Can GPT-3 see?”, by predicting that the model is more likely correct about GPT-3's sight if it knows about GPT-3 generally than if it does not. This would be a conceptual model of the LLM that allows us to predict its behavior.

The goal is to build models for which that kind of understanding is possible. Thus, embodiments consistent with the present principles achieve that goal by modeling the conceptual knowledge of a LLM and predicting when the LLM will be correct from that model. The conceptual model determined is based on a LLM's answers to questions about background knowledge relevant to a particular anchor task (e.g., question answering), which is assumed to be a reasonable though imperfect measurement of what the LLM can be said to “know.” From this and a measurement of question answering performance, a conceptual consistency is computed, quantifying whether a model's knowledge of relevant background is consistent with its ability to perform the anchor task. Unlike standard approaches to evaluation this approach relies on example specific context.

Defining background knowledge is important to the approach presented herein because it needs to be relevant enough to establish meaningful consistency. Given the target query “Can GPT-3 see?”, a relevant background query might be “Was GPT-3 built by OpenAI?” while “Is the sky blue?” would be an irrelevant query (see Table 1 below).

TABLE 1
Example target question with relevant
and irrelevant background knowledge.

| | | Relevant | | |
|---|---|---|---|---|
| | Irrelevant | Background: | | |
| | Background: | Was GPT-3 | Target Task: | |
| | Is the sky | built by | Can GPT-3 | Conceptually |
| | blue? | OpenAI? | see? | Consistent |
| Model 1 | correct | wrong | wrong | ✓ |
| Model 2 | correct | correct | wrong | X |
| Model 3 | correct | correct | correct | ✓ |

Instead, requiring a background fact to logically support the target query in some way, it can be said that a background fact is relevant if it can tell us something about how a typical human language user would respond. Given a ground truth response Y to the target with human response and respective responses Y_{K} and Ŷ_{K} to a potentially relevant background fact, a relevance is defined using a conditional probability. If P (Y=Ŷ|Y_{K}=Ŷ_{K})≠P (Y=Ŷ) then the background fact is relevant because it is not independent of the target and gives us information about whether the speaker will be right or wrong. Knowing GPT-3 was built by OpenAI makes it more likely that someone will also know GPT-3 cannot see because it is true and involves relevant concepts. While knowing the color of the sky is laudable, there's no conceptual overlap with GPT-3's ability to see. A model is conceptually consistent when its knowledge of relevant background information—sharing concepts with the target—is consistent with its ability to answer questions correctly. This kind of conceptual relevance is one of the focuses of the presented approach.

Specifically, after extracting background knowledge, prompting is used to measure how a given LLM handles the background knowledge and how it performs at the anchor task. For this, three varieties of generative language models were studied across multiple scales up to 66 billion parameters, and majority vote style prompting procedure was used to maximize the robustness of the approach to linguistic variations.

As will be described below in further detail with respect to the Figures, in some embodiments the techniques to determine a conceptual consistency metric for LLMs to measure the LLMs' understanding of relevant concepts include: Extracting conceptually relevant background knowledge with respect to examples from an anchor task and map them onto background knowledge questions; using a zero-shot prompting procedure applied to generative language models to measure LLM performance; measuring conceptual consistency, focusing on generative language models and showing that consistency does increase with model size up to 66 billion parameters; and reporting conceptual patterns in model behavior (i.e., outputting an indication of the conceptual consistency score).

The aforementioned embodiments and features are now described below in detail with respect to the Figures.

FIG. 1 depicts embodiments of a conceptual consistency determination system 100 that is configured to measure the conceptual consistency of large language models (LLM) (e.g., LLM 102).

In some embodiments, the conceptual consistency determination system 100 includes one or more LLMs 102, prompting system 106, LLM performance evaluation module 110, and LLM conceptual consistency evaluation module 124. In some embodiments, the one or more LLMs 102 whose conceptual consistency is determined is not part of system 100 but may be one or more external LLMs. Similarly, in some embodiments, the prompting system 106 may be an external system.

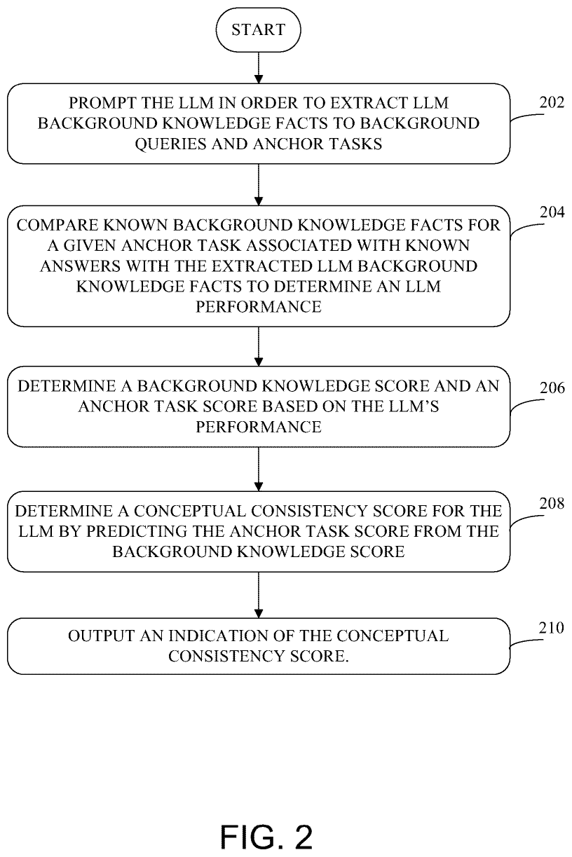

In operation, as shown in the flow chart of FIG. 2, the LLM 102 is prompted in order to extract LLM background knowledge facts (LLM BKF) 104 to background queries and anchor tasks, which are shown and described as prompts 108 in FIG. 1 (FIG. 2, 202). The background queries and associated anchor tasks may be generated by prompting system 106 which may use various well-known prompting templates and prompt engineering techniques to create the set of background queries and anchor tasks to prompt the LLM to extract the LLM background knowledge facts 104. Similar background queries for a given anchor task associated with known answers may be used to prompt existing external data sources 114 in order to obtain known background knowledge facts 116. In some embodiments, the same prompts 108 generated and used to extract LLM BKF 104 from LLM 102 may optionally be used to extract known BKF 116 from the external data sources.

In some embodiments, the LLM background knowledge facts extracted from the LLM are each represented by a tuple including at least two concepts and a relation between those concepts. In some embodiments, for each fact tuple, concepts and relation are transformed into a question using a natural language template of questions for the relation.

Once the LLM background knowledge facts 104 are extracted from the LLM 102 at 202, they are compared with the known background knowledge facts 116 from the external data sources at 204 in order to determine an LLM performance. In some embodiments, this is performed by the LLM performance evaluation module 110. At 206, the LLM performance evaluation module 110 determines the LLM background knowledge score 120 and anchor task score 122 based on the LLM's performance.

At 208, the conceptual consistency score 126 for the LLM is determined by predicting the anchor task score from the background knowledge score. Finally, at 210, the indication of the conceptual consistency score is output. In some embodiments, the conceptual consistency score is a measure of an average precision of an ability to predict the anchor task score based on the background score.

As discussed above, to measure conceptual consistency, the background knowledge of the LLM 102 is measured (i.e., LLM background knowledge score 120), and the Question Answering (QA) performance of the LLM 102 is measured (i.e., anchor task score 122). Then, the conceptual consistency score 126 for the LLM 102 is determined by predicting the QA performance of the LLM (i.e., anchor task score 122) using the LLM background knowledge score 120. In order measure/determine the background knowledge score 120 and anchor task score 122, the following is described in detail below: (A) extraction of known background knowledge facts 116 from existing external data sources 104 in the form of questions with known answers, (B) how prompting of the LLM 102 is used to answer both background and anchor questions, and finally (C) the conceptual consistency metric which correlates the two by predicting the LLMs anchor task score from the background knowledge score.

### A. Known Background Knowledge Facts Extraction

To obtain the desired known background knowledge facts 116, question answering (QA) problems are focused on first, and a knowledge base of content relevant to the specific QA task is assumed to be available (i.e., data sources 114). Examples in the QA dataset consist of a question Q with corresponding choices S={s1, . . . , s|S|}, one of which is the correct answer A. These choices can be single words or short phrases. The anchor task query is called (Q, S, A) because the first task is to find conceptually relevant background knowledge with respect to that information.

The background knowledge for a given anchor corresponds to a list of facts in a knowledge base. Each fact F=(c1, r, c2) is represented by two concepts c1 and c2, and a relation r between those concepts. The task is to extract a set B={f1, . . . , f|B|} of facts conceptually relevant to the anchor and then map those facts onto questions that can be asked to roughly determine whether the LLM knows the background knowledge.

Extracting Background Facts: In some embodiments, the knowledge base can be thought of as a graph that connects concepts as nodes and relations as edges. To extract a list of concepts from a given text snippet, a basic tokenization is employed. Then stop words are removed and only nouns, verbs, adjectives, and adverbs are kept. In some embodiments, the set of concepts C is constructed as all concepts that appear in any part of the anchor query (Q, S, A) (including incorrect answers) and have overlap (>50% of words match) with a concept word or phrase from the knowledge base. In other embodiments, higher or lower percentages of word matches may be sued. For two different concepts c1, c2∈C, all tuples are considered from all paths length L or less which connect those concepts in the knowledge base, forming a cloud of relational information which constitutes the background knowledge for the anchor given by the selected knowledge base.

In some embodiments, where the list of background knowledge tuples is extremely large, it may be restricted to a more manageable yet still relevant list. This can be done by setting the maximum path length L to 1, essentially looking for concepts which appear in the anchor and are directly related to each other in the knowledge base.

Background Questions: In order to measure how well a LLM already knows the content captured by these tuples, they are automatically translated into natural language questions. In embodiments, this may be performed by prompt system 106 to produce natural language prompts 108. Consider a fact tuple (c1, r, c2). These three variables are substituted into a natural language template designed for the specific relation r. For example, the tuple (book, used for, school) would be translated into “Are book used for school?” Note that because the tuple exists in the knowledge base, the correct answer is known to be some version of “yes”. In some embodiments, a template such as those included in Table 2 may be used.

TABLE 2
All the relations with its corresponding
prompt style with a sample example.

| Relation | Prompt Style | Sample Instance |
|---|---|---|
| Is A | Is c¹ a c²? | Is security a department? |
| Has A | Does c¹ has a c²? | does house has a basement? |
| Antonym | Is c¹ an antonym of c²? | Is clever an antonym of dull? |
| Cause | Does c¹ cause c²? | does fencing cause small cuts? |
| Desires | Does a c¹ desires c²? | does a dog desires affection? |
| Form Of | Is c¹ a form of c²? | Is partying a form of party? |
| Made Of | Is the c¹ made of c²? | Is the car made of metal? |
| Part Of | Is c¹ a part of c²? | Is book a part of library? |
| Related To | Is c¹ related to c²? | Is doctor related to illness? |
| Similar To | Is c¹ similar to c²? | Is ridiculous similar to silly? |
| Synonym | Is c¹ a synonym of c²? | Is reply a synonym of answer? |
| Used For | Are c¹ used for c²? | Are clothes used for wearing? |
| At Location | Is c¹ at location c²? | Is door at location library? |
| Capable Of | Is a c¹ capable of c²? | Is a child capable of form |
| | | opinions? |

Relevance: This construction is likely to result in facts that are more relevant than irrelevant because each background query will share at least one concept with the target. Consider a human's response Y\hat{ }to a target query given their response Y\hat{ }K to a background query extracted by this procedure. By construction, the background query shares at least one concept with the target query. Since it is assumed that answers to questions are reflective of knowledge, answering the background query correctly indicates some knowledge of the background concepts, so it also indicates some knowledge of at least one of the concepts in the target query. As a result, the difference |P (Y=Y\hat{ }|YK=Y\hat{ }K)−P (Y=Y\hat{ })| for a human language user is expected to be positive for most background queries/prompts confidently.

Negative Background Knowledge: In all tuples so far, the relation r does exist between c1 and c2, so the correct answer is always “yes.” Language models are often biased towards certain outputs and, in this case, a “yes” bias was found to be particularly strong in some models, especially the smaller versions of OPT. As a result, those smaller models can outperform the larger ones even when they understand the background knowledge less, just because they are prone to saying “yes” to everything. This is resolved by extracting negative background knowledge tuples—to which the correct answer is some version of “no”—to mirror the positive ones.

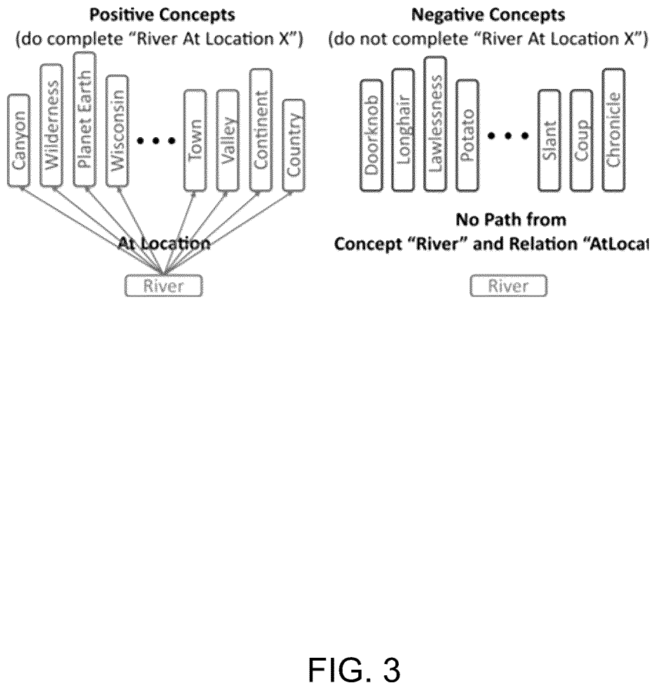

We frame the problem in a pairwise fashion: given a positive tuple (c1, r, c2) the negative tuple generation task is to find an alternative c̅ for which the correct answer is “no.” The pairwise nature ensures that background knowledge is measured in a balanced fashion to best address the “yes” (or “no”) bias issue. As depicted in FIG. 3, a set of choices C̅2 is formed that includes every concept c̅ in the knowledge base that meets 3 criteria:
1. c̅ does not form a valid tuple (c¹, r, c̅),
2. c̅ is not cyclic (i.e., not equal to to c¹), and
3. c̅ is in the English dictionary.

Our final choice for c̅2 is a single sample from the uniform distribution over C̅2. The amount of concepts in the English dictionary is quite large, hence the distribution space of C̅2 is curated after applying criteria 1 and 2 to keep most frequently used concepts. This choice is made in advance, treating background tuples as a dataset, so that even if a positive background tuple is used for multiple anchor queries it is always paired with the same negative tuple. However, if there are multiple choices of c2 for the same c1 and r, then c2 is sampled independently for each of those choices. The final set of background tuples for an anchor query includes all positive tuples that match that anchor along with all negative tuples that are paired with the positives.

B. Answering Background and Anchor Questions with Prompting

As described above with respect to step 202 in FIG. 2, LLM background knowledge facts are now extracted to a given background question or anchor question from the LLM 102. Instead of using just one question and one answer, many variations on the same question and many potential answers are considered, taking the combination assigned the highest likelihood by the model as its predicted answer to the question. To vary the question presentation, the question generated from the templates is substituted into 6 meta-prompts, which are minor variations on how to ask the question as reported in Table 1.

TABLE 1
Meta-prompts utilized for question generation.
Meta-Prompts

1.<question>?
2.<question>. Is this true?
3.Answer this question as‘<l [symbol] bel a>’or-‘<label b>’.
Question: <question>?
4.Each item is a question and answer. Answer is o [symbol] e of‘<labe [symbol] a>’
or ‘<label b>’. Question: <question>? Answer:
5.Pick‘<label-a’ or ‘<la [symbol] el b>’. Question: <question>? Answer:
6. Question: <question>? Answer:

In some embodiments, to vary answer presentation, multiple positive and negative words may be used as potential answers including {(Yes, No), (True, False), (Right, Wrong), (Correct, Incorrect), (Positive, Negative), (Pass, Fail), (On, Off)}, and the like. In this example, this results in 6×14=84 model inputs for each query, and the model's likelihood of each potential answer word is evaluated. In some embodiments, note that no sampling may be required because only use single answer words are used. The final answer to a question is positive if the input with the highest likelihood used a positive answer word, and otherwise the answer is negative.

In some embodiments, this variation was advantageous for achieving some consistency across linguistic variations when experimenting with the OPT language models.

### C. Measuring Conceptual Consistency

Above, it has been described that answers Â_{B}^{i,b} for the bth background knowledge question Q_{B}^{i,b} for the ith example in the anchor task dataset have been extracted. The anchor questions and answers are Q_{A}ⁱ and Â_{A}ⁱ. These questions and answers are translated into a LLM background knowledge score 120 and an anchor task score 122 that measure how well LLM 102 knows the background knowledge and well it performs at the anchor task. These background knowledge scores 120 and anchor task scores 122 are defined respectively for each anchor example using accuracy, wherein the background knowledge score (SB) 120 is a measure of how good the LLM is at verifying whether the extracted facts are true or false and is calculated as follows:

$${S}_{B}^{i} = ( {𝔼}_{b ∈ {P}_{i}} [ 〚 {A}_{B}^{i , b} == {\hat{A}}_{B}^{i , b} 〛 ] + {𝔼}_{b ∈ {N}_{i}} [ 〚 {A}_{B}^{i , b} == {\hat{A}}_{B}^{i , b} 〛 ] ) / 2 \qquad ( 1 )$$

and, wherein the anchor task score (S_{A}ⁱ) 122 is a measure of how good the LLM is answering questions through zero shot prompting and is calculated as follows:

$${S}_{A}^{i} = 〚 {A}_{A}^{i} == {\hat{A}}_{A}^{i} 〛 \qquad ( 2 )$$

where A_{B} and A_{A} are the correct answers, Nᵢ is the set of negative background tuples for anchor example i, Pᵢ is the set of positive background tuples for anchor example i, and [[⋅]] is the indicator function. Note that the background score weights negative and positive tuples evenly (e.g., average to the two functions).

Finally, the conceptual consistency score 126 of a model is computed on a given dataset and knowledge base by predicting the task score from the background score and reporting average precision:

$$C C = A P ( {S}_{A} , {S}_{B} ) \qquad ( 3 )$$

where AP( . . . ) measures the average precision of the S_{B} predictor.

Intuitively, this score will be high when the model answered more background knowledge questions correctly, so it is predicted that the model will perform better when it knows relevant background knowledge.

At least one advantage of this using the above method and system for determining a conceptual consistency score 126 is that a large model will become explainable in a way that allows developers to use and steer them more precisely based on conceptual knowledge.

### Example Results: Conceptual Consistency of Existing LLMs

In the following section, conceptual consistency of existing models is analyzed/determined using the techniques described above. Specifically, individual background and anchor task components of the conceptual consistency score of multiple existing public models are analyzed, it is shown qualitatively how performance on relations and concepts varies. In addition, biases related to prompting approaches are analyzed.

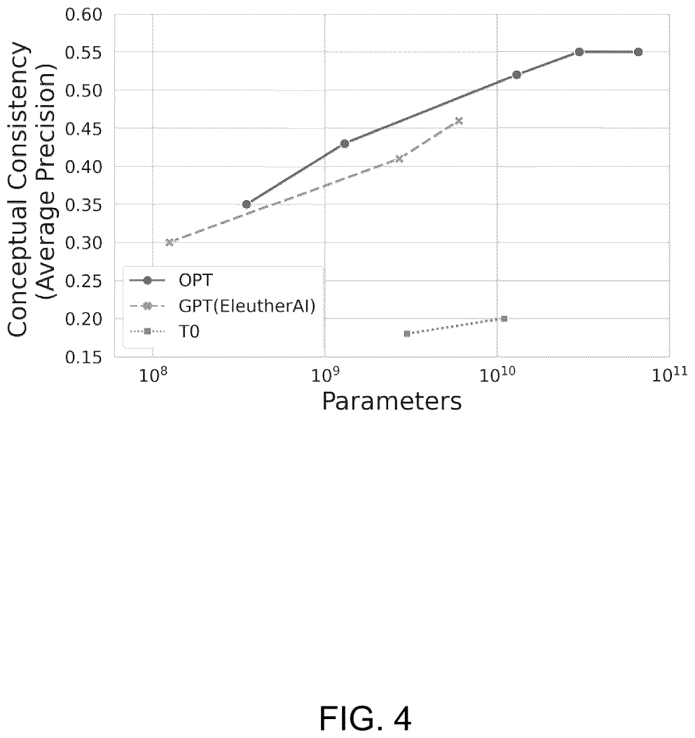

Conceptual Consistency: Conceptual consistency (Equation 3 above) for each LLM is determined and the results are shown in FIG. 4, which shows/measures the ability to predict whether an LLM will be correct from its knowledge of relevant background information. A model's knowledge of background information is somewhat predictive of its question answering correctness. The results show that the conceptual consistency score 126 (Y Axis in FIG. 4) generally grows with the scale of the model (X Axis) across all model classes, indicating that bigger models are not just more accurate, but also more consistent. A notable exception is between OPT-30B and OPT-66B, where there is no improvement from increased size. Both achieve the highest consistency among all models, but this data point suggests there may be diminishing returns. OPT models perform best, with GPT models close behind and TO demonstrating much worse performance. This indicates that OPT and GPT are much more conceptually consistent than TO. The difference could be due to the decoder only nature of OPT and GPT. It could also reflect a degree of forgetting in TO due to supervised fine-tuning, but this is doubtful because one of the many datasets TO was trained on was CSQA. However, it may also reflect the fact that the prompts created and used are not designed specifically for TO.

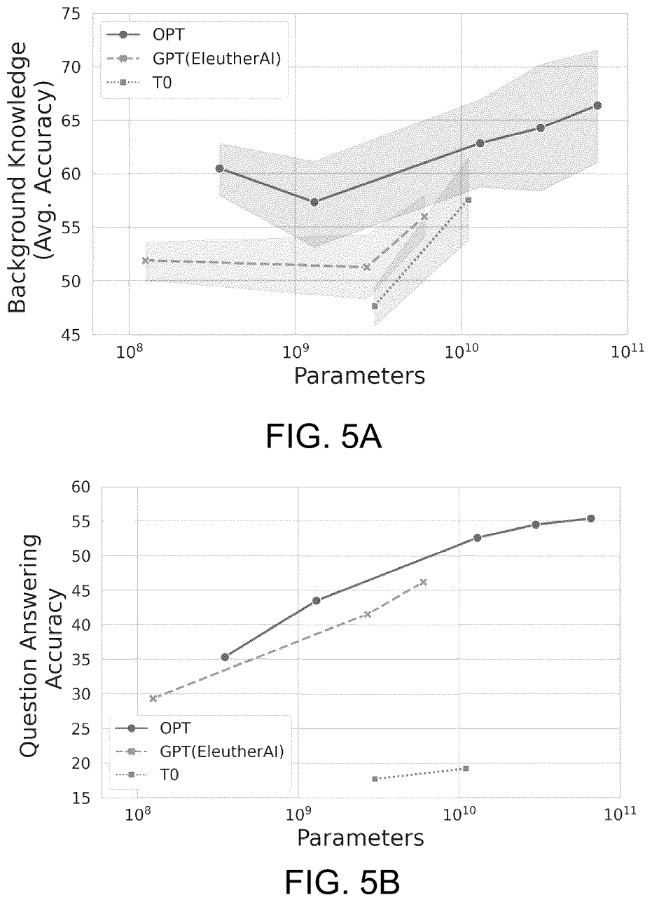

Background and Anchor Task Performance: The results also show measurement of the components of conceptual consistency (i.e., the aggregated background performance and anchor task performance), in FIG. 5A. As described above, the background knowledge score/performance indicates how good language models are at verifying whether the extracted background facts are true/false, averaged over the relations used, while the anchor task (e.g., CommonsenseQA question answering) performance is measured for the prompting approach used (e.g., zero-shot prompting, etc.).

For background knowledge, Equation 1 is computed averaged per relation and then averaged over all relations used (e.g., the 14 relations in Table 1 above). This is reported with a 95% confidence interval in FIG. 5A. There is an imbalance in how often these relations occur in the data, so this approach weights relations equally just for the purpose of assessing background knowledge. For anchor task knowledge, the anchor score (Equation 2) is shown in FIG. 5B, which is CSQA accuracy in these examples. In both cases, the prompting approach is able to extract correct answers from the LLMs analyzed. The trend in both cases is again an increase in performance with model size. This was expected in both cases, but it is interesting to note that the range of performance is smaller for background knowledge, suggesting that increasing size helps anchor task knowledge more than background knowledge, though the opposite is true for T0. Intuitively question answering is a more complex skill that builds on the less complex background knowledge completion skill. From that perspective, these results are also evidence of a skill hierarchy like Bloom's Taxonomy, where simpler skills are learned before more complex ones. As for conceptual consistency, OPT models have higher performance compared to GPT and T0 models, and this is likely due to the same reasons discussed previously. It is however notable that the gap between T0 and the other models is much smaller for background knowledge. Also, a marginal increase in performance is seen between OPT-30B and OPT-66B for both task and background knowledge.

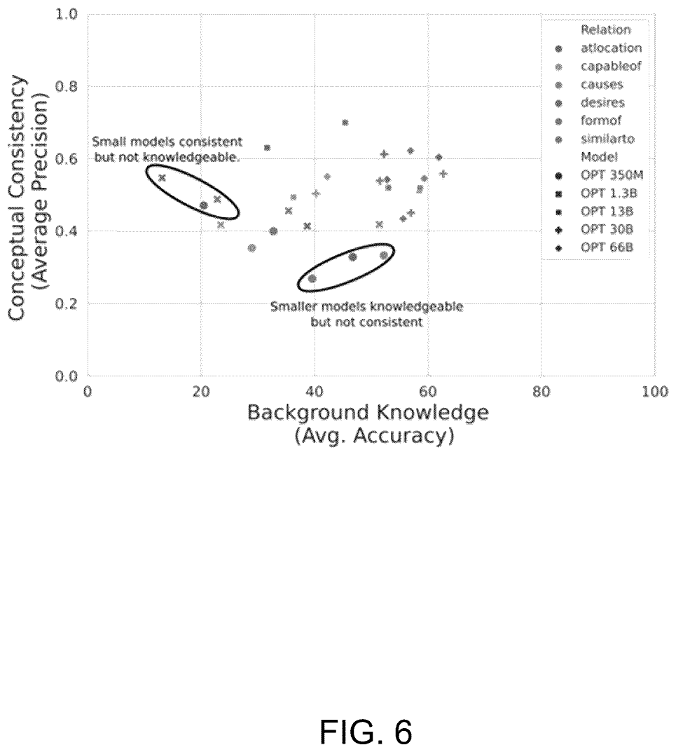

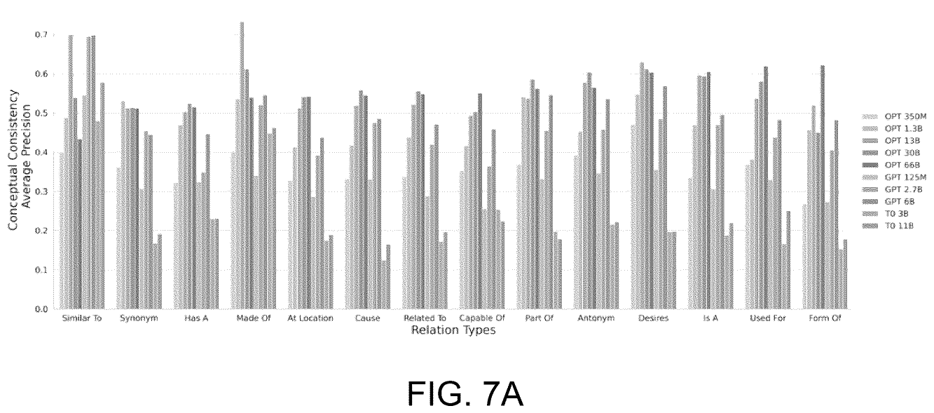

Background vs Consistency: FIG. 6 is a scatter plot of background knowledge score vs. conceptual consistency score for existing LLMs which shows where background knowledge and consistency diverge. In FIG. 6, the background score is plotted versus conceptual consistency score for 6 relations that seemed to be more like outliers. Smaller models tend to be further from the diagonal, either being inconsistent but knowledgeable or consistent without knowing much. Relations also behave differently. Small models don't know the “desires” relation very well, but they are somewhat conceptually consistent about it, to the point that even though large models get to know the relation better they do not get more consistent about it. In the reverse direction, all model scales know roughly the same amount about “causes” background information, but the larger models are much more conceptually consistent about it.

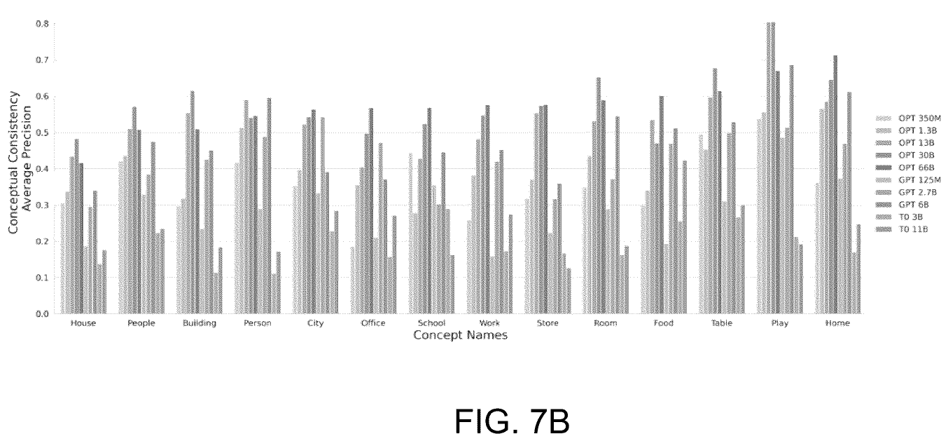

Concept and Relation Level Consistency: In this section, conceptual consistency at the level of relations and concepts is analyzed in FIGS. 7A and 7B. FIG. 7A shows consistency for all relations. In FIG. 7B, 14 of the most occurring concepts with minimum occurrence count of 28 is shown. Though the overall trend is that larger models know more background knowledge, there are variations in which concepts and relations a model is consistent about. For example, some of the largest models (OPT-66B and OPT-30B) are outperformed by smaller versions of OPT, GPT(EleutherAI), and even T0 on the “Similar To” relation. Less extreme differences occur for other relations like “Made Of”, and again lesser differences occur for concepts like “Play”. This sensitivity of relations indicates the prompts created and used (e.g., via prompting system 106), which are designed per relation, could be a factor. Another observation is that the increase in performance with size is robust for GPT and T0, but that trend is more often violated for the OPT models. In general, trends in concept consistency are more robust than trends in relation consistency.

At least one advantage of this using the above method and system for determining a conceptual consistency score 126 is that a large model will become explainable in a way that allows developers to use and steer them more precisely based on conceptual knowledge. Specifically, as shown above, the novel conceptual consistency determination methods and systems described herein can predict whether an LLM's knowledge of relevant background information is consistent with their ability to answer questions correctly. For a particular anchor task/question, background knowledge was extracted from a knowledge base of related concepts and used prompting to measure whether popular open source LLMs knew that background information. In addition, the LLMs ability to answer common sense questions correctly was also measured. This information was used to measure conceptual consistency by predicting correctness from the background knowledge measure. It was found that LLMs have a moderate amount of conceptual consistency, and that it increases with scale. It was also found that, while knowledge of background information increases with model scale, it does not increase nearly as much as correctness or conceptual consistency, indicating that models' size has a larger impact on difficult tasks than simpler ones and providing evidence of a hierarchy of related skills.

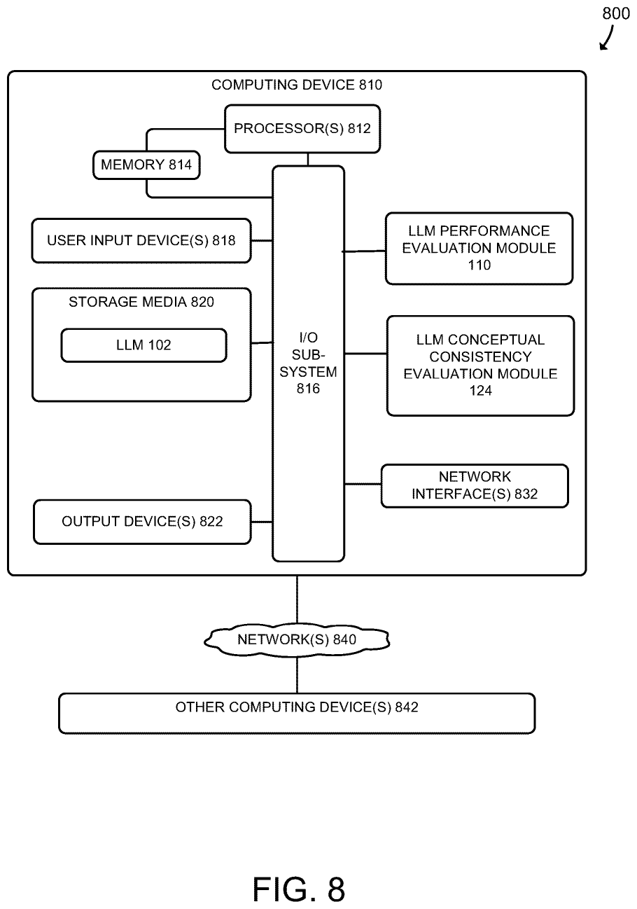

Referring now to FIG. 8, a simplified block diagram of an exemplary computing environment 800 for the conceptual consistency determination system 100. The illustrative implementation 800 includes a computing device 810, which may be in communication with one or more other computing systems or devices 842 via one or more networks 840. In some embodiments, portions of the machine learning system 100 may be incorporated into other systems or interactive software applications or work with such systems or applications. Such applications or systems may include, for example, operating systems, middleware or framework (e.g., application programming interface or API) software, and/or user-level applications software (e.g., a search engine, a virtual personal assistant, a messaging application, a web browser, another interactive software application or a user interface for a computing device).

The illustrative computing device 810 includes at least one processor 812 (e.g. a microprocessor, microcontroller, digital signal processor, etc.), memory 814, and an input/output (I/O) subsystem 816. The computing device 810 may be embodied as any type of computing device such as a personal computer (e.g., a desktop, laptop, tablet, smart phone, wearable or body-mounted device, etc.), a server, an enterprise computer system, a network of computers, a combination of computers and other electronic devices, or other electronic devices. Although not specifically shown, it should be understood that the I/O subsystem 816 typically includes, among other things, an I/O controller, a memory controller, and one or more I/O ports. The processor 812 and the I/O subsystem 816 are communicatively coupled to the memory 814. The memory 814 may be embodied as any type of suitable computer memory device (e.g., volatile memory such as various forms of random access memory).

The I/O subsystem 816 is communicatively coupled to a number of components including one or more user input devices 818, one or more storage media 820, one or more output devices 822 (e.g., display screens, speakers, LEDs, etc.), one or more model training modules 106, one or more model checking modules, 116, one or more LLM performance evaluation modules 110, one or more LLM conceptual consistency evaluation modules, one or more reward repair modules, and one or more network interfaces 832.

The storage media 820 may include one or more hard drives or other suitable data storage devices (e.g., flash memory, memory cards, memory sticks, and/or others). In some embodiments, portions of systems software (e.g., an operating system, etc.), framework/middleware (e.g., APIs, object libraries, etc.), and/or, in some embodiments, LLM 102 reside at least temporarily in the storage media 820.

The one or more network interfaces 832 may communicatively couple the computing device 810 to a network, such as a local area network, wide area network, personal cloud, enterprise cloud, public cloud, and/or the Internet, for example. Accordingly, the network interfaces 832 may include one or more wired or wireless network interface cards or adapters, for example, as may be needed pursuant to the specifications and/or design of the particular computing system 800. The network interface(s) 832 may provide short-range wireless or optical communication capabilities using, e.g., Near Field Communication (NFC), wireless fidelity (Wi-Fi), radio frequency identification (RFID), infrared (IR), or other suitable technology.

The other computing system(s) 842 may be embodied as any suitable type of computing system or device such as any of the aforementioned types of devices or other electronic devices or systems. The computing system 800 may include other components, sub-components, and devices not illustrated in FIG. 8 for clarity of the description. In general, the components of the computing system 800 are communicatively coupled as shown in FIG. 8 by electronic signal paths, which may be embodied as any type of wired or wireless signal paths capable of facilitating communication between the respective devices and components.

In the foregoing description, numerous specific details, examples, and scenarios are set forth in order to provide a more thorough understanding of the present disclosure. It will be appreciated, however, that embodiments of the disclosure may be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described may include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to effect such feature, structure, or characteristic in connection with other embodiments whether or not explicitly indicated.

Embodiments in accordance with the disclosure may be implemented in hardware, firmware, software, or any combination thereof. Embodiments may also be implemented as instructions stored using one or more machine-readable media, which may be read and executed by one or more processors. A machine-readable medium may include any mechanism for storing or transmitting information in a form readable by a machine (e.g., a computing device or a “virtual machine” running on one or more computing devices). For example, a machine-readable medium may include any suitable form of volatile or non-volatile memory.

Modules, data structures, and the like defined herein are defined as such for ease of discussion, and are not intended to imply that any specific implementation details are required. For example, any of the described modules and/or data structures may be combined or divided into sub-modules, sub-processes or other units of computer code or data as may be required by a particular design or implementation.

In the drawings, specific arrangements or orderings of schematic elements may be shown for ease of description. However, the specific ordering or arrangement of such elements is not meant to imply that a particular order or sequence of processing, or separation of processes, is required in all embodiments. In general, schematic elements used to represent instruction blocks or modules may be implemented using any suitable form of machine-readable instruction, and each such instruction may be implemented using any suitable programming language, library, application-programming interface (API), and/or other software development tools or frameworks. Similarly, schematic elements used to represent data or information may be implemented using any suitable electronic arrangement or data structure. Further, some connections, relationships or associations between elements may be simplified or not shown in the drawings so as not to obscure the disclosure.

The foregoing methods and embodiments thereof have been provided in sufficient detail but it is not the intention of the applicant(s) for the disclosed system and embodiments provided herein to be limiting. Additional adaptations and/or modifications are possible, and, in broader aspects, these adaptations and/or modifications are also encompassed. Accordingly, departures may be made from the foregoing system and embodiments without departing from the spirit of the system.

This disclosure is to be considered as exemplary and not restrictive in character, and all changes and modifications that come within the guidelines of the disclosure are desired to be protected.

1. A method for measuring conceptual consistency of a large language model (LLM), the method comprising:
prompting the LLM in order to extract LLM background knowledge facts to background queries and anchor tasks;
comparing known background knowledge facts for a given anchor task associated with known answers with the extracted LLM background knowledge facts to determine an LLM performance;
determining a background knowledge score and an anchor task score based on the LLM's performance; and
determining a conceptual consistency score for the LLM by predicting the anchor task score from the background knowledge score; and
outputting an indication of the conceptual consistency score.

2. The method of claim 1, wherein the conceptual consistency score is a measure of an average precision of an ability to predict the anchor task score based on the background score.

3. The method of claim 1, wherein the LLM background knowledge facts extracted from the LLM are each represented by a tuple including at least two concepts and a relation between those concepts.

4. The method of claim 3, wherein for each fact tuple, concepts and relation are transformed into a question using a natural language template of questions for the relation.

5. The method of claim 1, wherein for two different concepts in the LLM, a cloud of relational information is formed from all tuples from all paths length L or less which connect those concepts in the LLM and forms the background knowledge for the anchor query provided by the LLM.

6. The method of claim 1, wherein the facts extracted from the LLM includes positive background knowledge and negative background knowledge.

7. The method of claim 1, wherein prompting the LLM includes using a zero-shot prompting approach.

8. The method of claim 1, wherein prompting the LLM includes varying questions presented to the LLM by substituting the question generated into a plurality of meta-prompts, wherein meta-prompts are variations on how to ask the question.

9. The method of claim 1, wherein the background knowledge score is a measure of how good the LLM is at verifying whether the extracted facts are true or false.

10. The method of claim 1, wherein the anchor task score is a measure of how good the LLM is answering questions through zero shot prompting.

11. A system for measuring conceptual consistency of a large language model (LLM), the system comprising:
a prompting system configured to prompt the LLM in order to extract LLM background knowledge facts to background queries and anchor tasks;
a LLM performance evaluation module configured to:
compare known background knowledge facts for a given anchor task associated with known answers with the extracted LLM background knowledge facts to determine an LLM performance; and
determine a background knowledge score and an anchor task score based on the LLM's performance; and
a LLM conceptual consistency evaluation module configured to:
determine a conceptual consistency score for the LLM by predicting the anchor task score from the background knowledge score; and
output an indication of the conceptual consistency score.

12. The system of claim 11, wherein the conceptual consistency score is a measure of an average precision of an ability to predict the anchor task score based on the background score.

13. The system of claim 11, wherein the LLM background knowledge facts extracted from the LLM are each represented by a tuple including at least two concepts and a relation between those concepts.

14. The system of claim 13, wherein for each fact tuple, concepts and relation are transformed into a question using a natural language template of questions for the relation.

15. The system of claim 11, wherein for two different concepts in the LLM, a cloud of relational information is formed from all tuples from all paths length L or less which connect those concepts in the LLM and forms the background knowledge for the anchor query provided by the LLM.

16. The system of claim 11, wherein the facts extracted from the LLM includes positive background knowledge and negative background knowledge.

17. The system of claim 11, wherein prompting the LLM includes using a zero-shot prompting approach.

18. The system of claim 11, wherein prompting the LLM includes varying questions presented to the LLM by substituting the question generated into a plurality of meta-prompts, wherein meta-prompts are variations on how to ask the question.

19. The system of claim 11, wherein the background knowledge score is a measure of how good the LLM is at verifying whether the extracted facts are true or false, and wherein the anchor task score is a measure of how good the LLM is answering questions through zero shot prompting.

20. A non-transitory computer readable storage medium having stored thereon instructions that, when executed by one or more processors, cause the one or more processors to perform operations for measuring conceptual consistency of a large language model (LLM) that include:
prompting the LLM in order to extract LLM background knowledge facts to background queries and anchor tasks;
comparing known background knowledge facts for a given anchor task associated with known answers with the extracted LLM background knowledge facts to determine an LLM performance;
determining a background knowledge score and an anchor task score based on the LLM's performance; and
determining a conceptual consistency score for the LLM by predicting the anchor task score from the background knowledge score; and
outputting an indication of the conceptual consistency score.
